(19) United States
(12) Patent Application Publication
(10) Pub. No.: US 2021/0153515 A1
(43) Pub. Date: May 27, 2021

(54) Freezing Method, And Method And Device For Drying Food, in Particular Fruits And Vegetables

(71) Applicant: ELEA VERTRIEBS-UND VERMARKTUNGSGESELLSCHAFT MBH, Quakenbrück (DE)

(72) Inventors: Robin Ostermeier, Osnabruck (DE); Vanessa Voelkel, Steinfurt (DE); Stefan Toepfl, Osnabruck (DE)

(21) Appl. No.: 16/618,212

(22) PCT Filed: Jun. 12, 2018
(86) PCT No.: PCT/EP2018/065447

§ 371 Date: Nov. 29, 2019

(30) Foreign Application Priority Data
Jun. 20, 2017 (DE) 10 2017 210 327.2

(51) Int. Cl. A23B 7/015; A23B 7/024; A23B 7/04

(52) U.S. Cl. CPC A23B 7/015; A23B 7/0408; A23B 7/024

(57) ABSTRACT

This invention refers to a method for freezing food, in particular fruit and vegetables, and a method for drying food, in particular fruit and vegetables, by exposing the food to a negative pressure and removing water from the food while exposed to the negative pressure. The present invention also refers to a device for drying food, in particular fruit and vegetables, comprising a negative pressure chamber, a vacuum pump for generating a negative pressure in the negative pressure chamber, and a liquefier connected to the negative pressure chamber by a closable valve. The present invention provides a method and a device for freezing or drying food, in particular fruit and vegetables, which maintains product properties of the food, such as color, taste and structure, as far as possible and which at the same time is as time-, energy- and cost-saving as possible, by conditioning the food during the methods by applying an electric field and in that the device comprises at least one capacitor for generating an electric field.

The present invention refers to a method for freezing food, in particular fruit and vegetables.

The present invention also refers to a method for drying food, in particular fruit and vegetables, wherein the food is exposed to a negative pressure and water is removed from the food while exposed to the negative pressure.

The present invention also refers to a device for drying food, in particular fruit and vegetables, comprising a negative pressure chamber, a vacuum pump for generating a negative pressure in the negative pressure chamber, and a liquefier connected to the negative pressure chamber by a closable valve.

The preservation of food, for example by freezing or drying, is well known. Drying, i.e. the removal of water, is one of the most important conservation processes in the food industry. Various drying methods are used, whereby conventional drying processes with a phase transition of the water under supply of thermal energy are widespread. However, these drying processes are very cost-, energy- and time-intensive. In addition, thermal stress and the duration of drying can have a negative impact on product quality and, for example, lead to loss of nutrients and flavorings or undesirable discoloration of the food.

The food industry is therefore interested in drying as gently as possible.

For example, the drying of fruit for mueslis takes place by means of freeze drying. In freeze drying or lyophilization, drying takes place bypassing the liquid aggregate state. Drying is based on the physical process of sublimation, in which ice crystals are converted directly into the gaseous state without the occurrence of a liquid phase in between.

For this purpose, the food to be dried which contains water is first frozen. In the frozen state, water is removed from the food by sublimation by applying a vacuum and adding heat energy to the product under negative pressure, which sets the sublimation process in motion.

However, freeze-drying is particularly time-consuming and cost-intensive, so that it is desirable to improve this process both in terms of freezing food and removing water under negative pressure.

In view of the problems mentioned above, it is the object of the present invention to provide a method and a device for freezing and drying food, in particular fruit and vegetables, which maintains the product properties of the food, such as color, taste and structure, as far as possible and which at the same time is as time-, energy- and cost-saving as possible.

The present invention solves this problem by means of the above-mentioned method for freezing food and the above-mentioned method for drying food by conditioning the food by applying an electric field.

The aforementioned device for drying food solves this object by comprising at least one capacitor for generating an electric field.

Surprisingly, it has been shown that the freezing of food, especially fruit and vegetables, can be accelerated by conditioning the food by applying an electric field. The applied electric field can in particular be a non-thermal electric field in which the upper energy limit is dimensioned in such a way that essentially no heating of the food takes place in the sense of ohmic heating. In addition, the conditioning of the food by applying an electric field not only leads to a faster and thus more energy-saving freezing of the food, but also surprisingly favors the removal of water from the food under negative pressure. In addition, the method according to the invention promotes the preservation of the original product quality and leads to a considerable improvement in structure preservation through lower shrinkage and less change in the bulk density of the products. In particular, it reduces shrinkage and leads to a better preservation of the color and structure of the food.

The invention can be further improved with the following further developments and embodiments, each of which being advantageous in itself and can be combined with each other as desired.

It has been shown that food can be dried in a particularly gentle and resource-saving way by freezing the food before applying the negative pressure. The food can be cooled to below −18° C. in one embodiment, which can be easily done in standard freezers and is a sufficiently low temperature to allow subsequent removal of water under vacuum, i.e. at negative pressure.

For the purposes of this application, the terms negative pressure and vacuum are used synonymously and are to be understood as meaning that the pressure is below a pressure of 1 bar, preferably below 0.1 bar. Gentle preservation means that the food is preserved, while essential product properties such as color, taste, smell and/or structure are essentially retained.

It has been shown that water can particularly well be removed from food if, according to another embodiment, the food is frozen through before the negative pressure is applied. Frozen through in the sense of the present invention means that all water in the food which can be frozen at temperatures below 0° C. is converted to the solid state. However, bound water or special electrolytes, which only freeze at very low temperatures of below −20° C., for example, can form an “unfreezable”, still liquid residue in the frozen food.

The conditioning of the food according to the invention by applying an electric field has a particularly advantageous effect on the drying of the food if the water is removed from it by sublimation. In this way, i.e. when drying as freeze-drying, the food is conserved very gently. Vacuum drying or microwave vacuum drying is also possible.

According to a further embodiment of the method according to the invention for drying food, the food is frozen. According to an embodiment, the conditioning of the food can be performed by applying an electric field before the step of freezing.

The food can be conditioned particularly effectively by means of electric pulses. For example, the device according to the invention may comprise at least two electrodes connected to a pulse generator. The electric field, especially the electric pulses, can be generated by direct contact of the capacitor or its electrodes with the food, as well as by conductive fluids, whereby the food to be treated is completely or partially placed into the conductive fluids. Various electrode shapes can be used, such as plate, ring, grid, hollow or flow-through electrodes. A high-voltage pulse generator can be used as a pulse generator, which generates electric fields in the form of short pulses in the micro to millisecond range of a high voltage in the kilovolt range. Such high-voltage pulses cause electroporation in food, which in particular results in a simple and non-thermal permeabilization of the cell membrane. In order to optimize time and energy, the food can be conditioned with at least 2 electric pulses, preferably 10 to 200 and particularly preferably 30 to 50 electric pulses.

When the food is conditioned by applying an electric field, an energy input of at least 0.15 kJ/kg into the food can occur. An energy input of this magnitude is sufficient to condition the food in an advantageous way for faster freezing or gentler and faster removal of water. In order to optimize the energy input, the energy input can be adapted to the food to be treated. Energy inputs of 0.15 to 0.5 kJ/kg, for example, are sufficient for freezing or drying bananas. For the freezing or drying of harder foods, for example carrots, a higher energy input of more than 0.5 kJ/kg, especially above 1 kJ/kg, for example 1 to 5 kJ/kg can be advantageous.

It has been shown that it is advantageous to apply an electric field of 0.5 kV/cm to 2 kV/cm. Such field strengths can be achieved with commercially available industrial capacitors and prevent unwanted thermal effects that lead to undesired product changes.

The method according to the invention of freezing or drying food may also include a step of pre-dewatering the food, before the step of freezing or before or during the removal of water at negative pressure. Surprisingly, it has been shown that conditioning the food by applying an electric field causes liquid to escape from the cells and accumulate on the surface of the food. This released liquid can be pre-dewatered, for example by blowing, centrifuging, pre-drying or suction, for example by means of absorbing substances. The pre-dewatering step can, for example, be accelerated and made more effective by first mechanically partially dewatering the food, for example by pressing it, and then removing the released liquid. The pre-dewatering step reduces the time required for the subsequent freezing of the food or drying while exposed to the negative pressure. In an embodiment of the method according to the invention for drying food, the food can first be conditioned by means of an electric field, then it is pre-dewatered, for example by means of mechanical partial de-watering with subsequent removal of the released liquid, for example by blowing, centrifuging, pre-drying, suction, then the food is exposed to a negative pressure and the residual water is removed while exposed to the negative pressure, for example as part of freeze-drying. The device according to the invention may, for example, include a pre-dewatering device for removing liquids escaping from the food. The pre-dewatering device may include a device for removing released liquids, such as a blowing device, a centrifuge, a dryer, a suction device and/or a liquid-absorbing substance. The pre-dewatering device may also have a mechanical de-watering device which acts mechanically on the food and releases cell fluid from the food. The mechanical partial de-watering device can, for example, include a pressing device.

The method according to the invention for freezing or drying food may also include conditioning of the food prior to the freezing or drying step by applying an electric field, said conditioning enabling substances to be absorption into the food, in particular the food cells, said substances influencing and/or stabilizing the cell structure. In this way, not only substances influencing or stabilizing the structure of the food, but any kind of additives can be added to the food before freezing or drying and introduced into the cell structure. For example, additives could be added to the food to achieve chemical, physical or physiological effects. For example, such additives may be flavor, color, odor, utility and/or nutritional value regulating, utility and/or nutritional value stabilizing, or an additive that ensures trouble-free further processing of the food. Additives that regulate or stabilize the utility or nutritional value include in particular additives that promote the chemical and microbial shelf life of food products. Additives which ensure the trouble-free further processing of the food are, in particular, additives which maintain or improve the technological properties of the food, for example the improvement of baking properties, spreadability, pourability or machine suitability.

The removal of water can be carried out in a time and resource saving manner by applying a negative pressure of at least 3 mbar, preferably a negative pressure of 0.5 to 2 mbar. A negative pressure of at least 3 mbar means a pressure of 3 or less mbar. In this pressure window, removal of water can be carried out by sublimation at temperatures that are not too low, thus eliminating unnecessary energy for undercooling the product, but at the same time sufficiently low for the product to be reliably frozen and preserved.

The methods according to the invention of freezing and drying food may be used in particular for fresh food such as fresh fruit and vegetables. A fresh food is an essentially untreated food that can also be bought at a farmer's market or supermarket.

According to one embodiment, the temperature of the food is always below 40° C. throughout the entire drying process. The preferred temperature of the food during the drying process up to the water removal stage is always below 30° C., preferably below room temperature (approximately 20° C.) and particularly below 10° C. or refrigerator temperature, which corresponds to approximately 7° C. In one embodiment, the temperature of the food is below or in the range of the temperature of the regular cold chain of the food during the entire drying process until the removal of water. In the case of removal of water, for example by freeze-drying, the temperature can then rise. In the case of a freeze dryer with heatable shelves, the product should have the shelf temperature at the end of the drying process; if this is above 30° C., for example, the product should also have this temperature at the end.

When treating hollow food, the food can be opened before conditioning according to another embodiment. A hollow food is a food that contains a cavity filled with air, as is the case, for example, with many husk fruit, bell pepper or peperoni, to name a few.

Finally, according to another embodiment, the method of drying food may include a post-drying step following the step of removing water while exposed to the negative pressure. The post-drying step is an option if you are looking for a preserved food with minimal residual moisture. Post-drying can, for example, be carried out as desorption to remove absorptively bound water. Post-drying, for example, can take place at very low pressures of less than 0.01, preferably less than 0.001 mbar. Additives, such as desorption agents, can be used as long as they are food-compatible and conducive to the post-drying process.

The conditioning of the products also allows the introduction of substances that influence the drying process or the product properties of the dried products. In particular, substances that influence the structure, such as calcium compounds to harden the product structure, sugars for water binding and softening or other substances such as salts, thickeners or similar agents, are advantageous.

In the following, the invention will be explained in more detail using advantageous embodiments with reference to the drawings and subsequent experiment examples. The advantageous further developments and embodiments presented here are independent of each other and can be combined with each other as required, depending on the application.

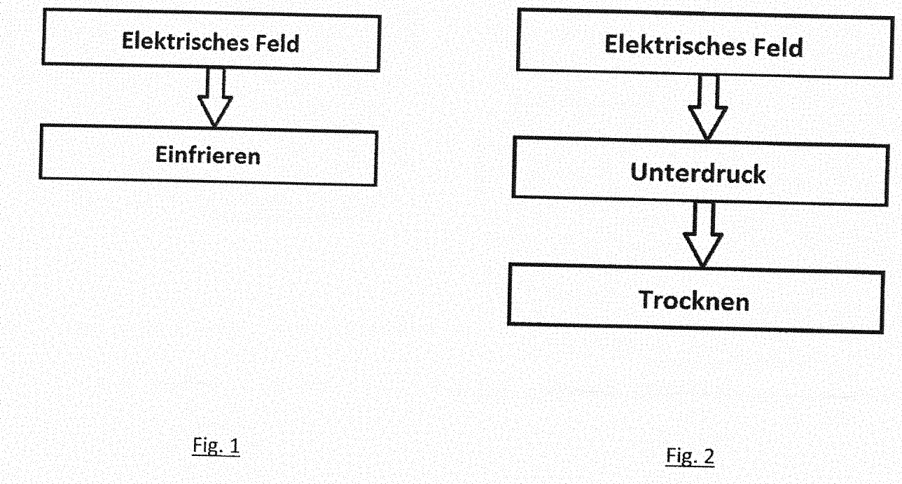

FIG. 1 shows an exemplary method for freezing food according to an exemplary embodiment;

FIG. 2 shows an exemplary method for drying food according to an exemplary embodiment;

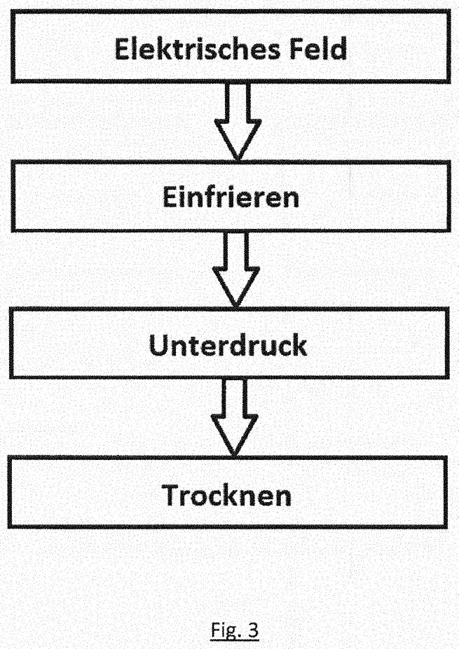

FIG. 3 shows an exemplary embodiment of a method for drying food according to another exemplary embodiment;

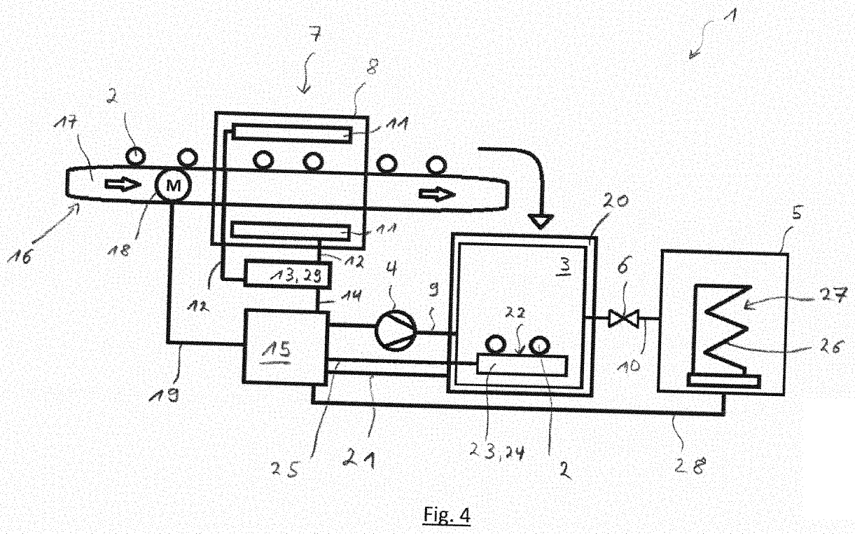

FIG. 4 shows an exemplary embodiment of a device according to the invention for drying food;

FIG. 5 shows a comparative representation of an untreated (left) bell pepper with a bell pepper (right) treated according to the invention after freeze-drying;

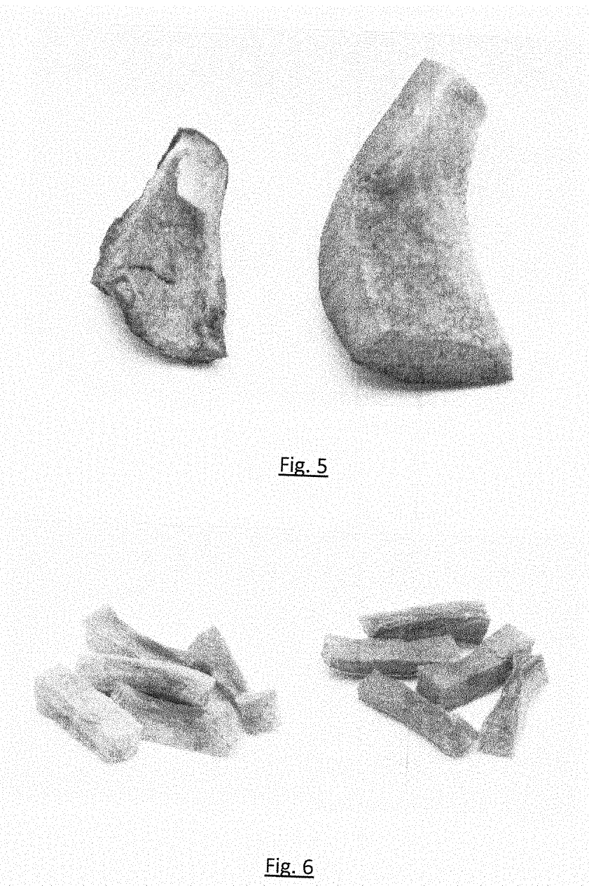

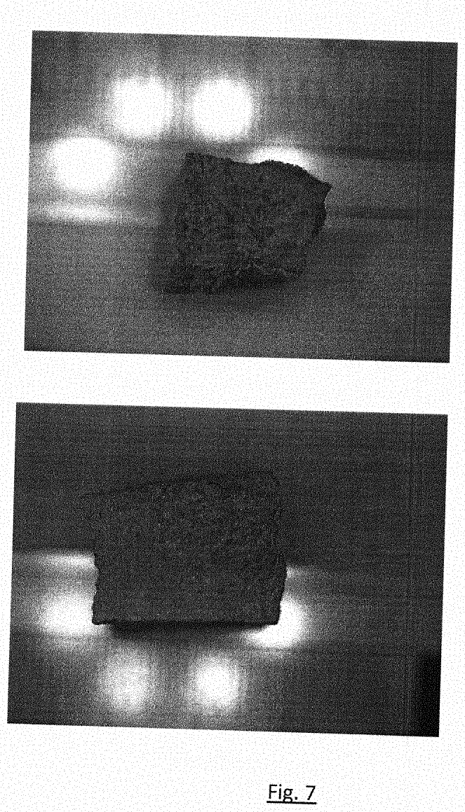

FIG. 6 shows a comparative illustration of untreated (left) carrot sticks and carrot sticks (right) treated according to the invention after freeze-drying;

FIG. 7 shows the representation of a comparative cross-section of an untreated (top) carrot and a carrot (bottom) treated according to the invention after deep-freezing; and

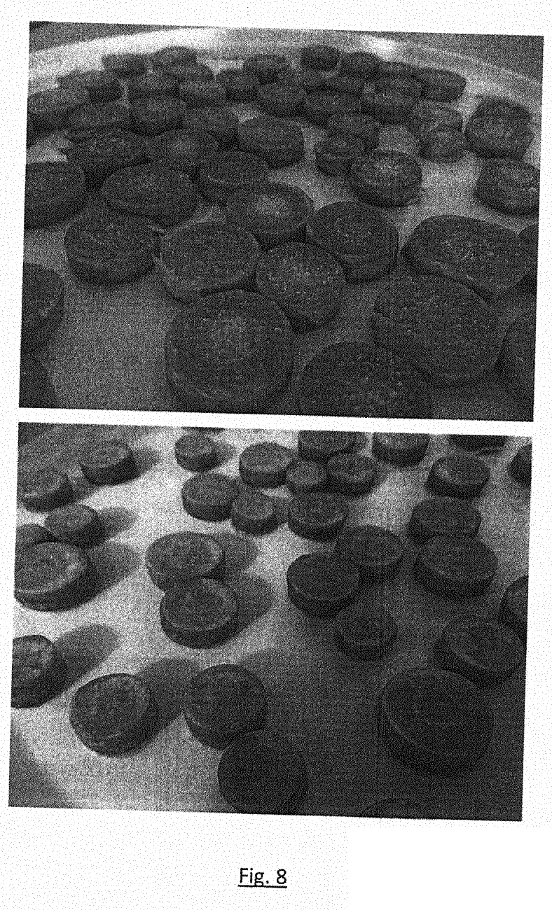

FIG. 8 shows a comparative representation of a frozen untreated (top) carrot with a carrot (bottom) frozen according to the invention after freezing; and

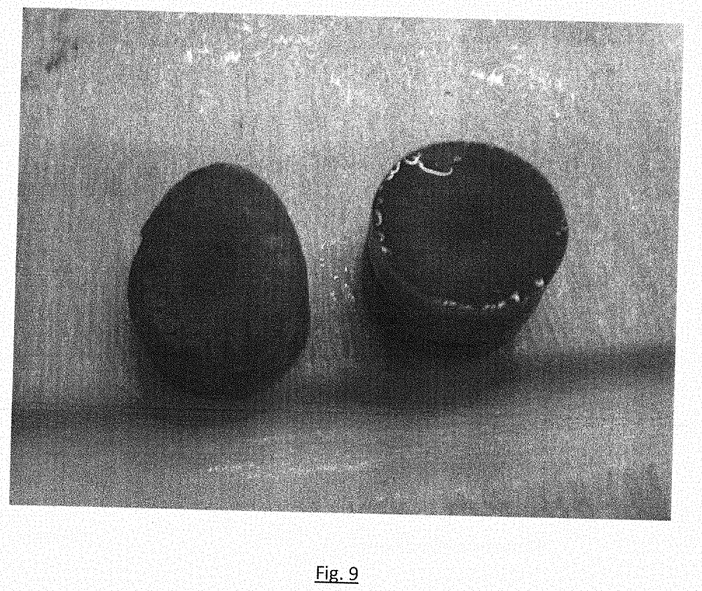

FIG. 9 shows a comparative representation of a carrot slice exposed to an electric field with an untreated carrot slice.

In the following, an exemplary method for freezing food according to the present invention is presented with reference to the flow chart of FIG. 1.

The method for freezing food, in particular fruit and vegetables, comprises a first step in which the food is conditioned by applying an electric field. It is then frozen in a second step. It has been shown that freezing can be accelerated by conditioning by applying an electric field. The formation of ice crystals begins earlier with conditioned foods than with foods that have not been treated with an electric field. The overall freezing rate, i.e. the time required for the food to be completely frozen, is also reduced if the method according to the invention is applied.

For conditioning, the food can be treated by means of electric pulses. The food can be conditioned with at least 2 electric pulses, preferably with 10 to 200 and particularly preferably with 30 to 50 electric pulses. If an electric field of 0.5 to 2 kV/cm is applied, an energy input of at least 0.15 kJ/kg is achieved.

The food treated according to the invention is in particular fruit and vegetables, especially fresh fruit and vegetables as it is available at a farmer's market or in the supermarket. If a hollow food, i.e. a food containing a cavity filled with air, such as peppers or peperoni, is treated, the hollow food can be opened before conditioning in order to avoid a negative effect on the product properties. Air inclusions can cause flashovers when an electric field is applied.

An exemplary method according to the invention for drying food, especially fruit and vegetables, in accordance with a first embodiment of the present invention is presented with reference to the flow chart in FIG. 2.

The method according to the invention for drying food, in particular fruit and vegetables, comprises the step of conditioning the food by applying an electric field. This step can be carried out essentially analogously to the application of an electric field as described in connection with the method for freezing food of the flow chart according to FIG. 1.

After the food has been conditioned by applying an electric field, the food is exposed to negative pressure. The food is then dried, which means that water is removed from it while exposed to the negative pressure.

Drying can take place in particular by sublimation, a particularly gentle method of drying. The negative pressure applied may preferably be less than 3 mbar, preferably less than 1 mbar.

In the following, an exemplary method for drying food according to a further embodiment of the present invention is presented with reference to the flow chart of FIG. 3.

The method according to the flow chart according to FIG. 3 is essentially the same as the method of the embodiment according to FIG. 2, but includes the additional step that the food is frozen before the negative pressure is applied. For example, the food can be cooled to below −18° C. for freezing, which can be done easily in a standard freezer. The final drying step can be optimized and the residual moisture reduced to a minimum by completely freezing the food before applying the negative pressure, i.e. the water in the food is completely transferred into the solid phase not only externally but also inside the food.

The product properties of the fresh food can be maintained particularly well in the food to be preserved by keeping the temperature of the food below 30° C., preferably below room temperature and particularly preferably below 10° C., throughout the drying process. In one embodiment, the cold chain of the food may not be interrupted when the methods according to the invention are carried out, which has a positive influence on the product quality and promotes the preservation of the food.

An example of a device for drying food according to method according to the invention is shown exemplarily in FIG. 4.

The device 1 shown in FIG. 2 for drying food 2, exemplarily shown as circles, comprises a negative pressure chamber 3, a vacuum pump 4 for generating a negative pressure in the negative pressure chamber 3, a liquefier 5 which is connected to the negative pressure chamber 3 via a closable valve 6. The device 1 also includes a capacitor for generating an electric field in a conditioning chamber 8. The vacuum pump is connected to the negative pressure chamber 3 by a suction line 9. The closable valve 6 is arranged in a connecting line 10, which fluidically connects the liquefier 5 with the negative pressure chamber 3.

The capacitor 7 of the embodiment shown comprises electrodes 11 which are connected to a voltage source 13 via power lines 12. In the embodiment shown, the two electrodes 11 of the capacitor 7 are arranged on opposite sides and parallel to each other. With such an electrode arrangement, a homogeneous electric field can be generated. However, other variants of the electrode arrangement are also conceivable, such as a coaxial or collinear arrangement.

A pulse generator 29, for example a high-voltage pulse generator such as a Marx generator, can be used as the voltage source 13 to generate electric pulses of a high voltage in the kilovolt range with a short duration in the micro to millisecond range.

The voltage source 13 is connected via a control line 14 to a central control unit 15, which controls the voltage source 13. In the embodiment shown the device 1 comprises a transport device 16 which feeds the food 2 to the conditioning chamber 8 and removes the conditioned food 2 from the conditioning chamber 8 and conveys it to the negative pressure chamber 3.

In the embodiment shown, the transport device 16 is a conveyor belt 17, which is driven by a motor 18. The transport device 16 continuously conveys the food 2 through the conditioning chamber 8 between the electrodes 11. When the food 2 is transported through the conditioning chamber 8, the food 2 is conditioned by applying an electric field. Of course, the transport of food 2 can also be carried out non-continuously or intermittently.

The motor 18 is connected to the central control unit 15 via a motor control line 19, so that the control unit 15 controls the transport speed of the transport device 16.

The conditioned food 2 is transferred to the negative pressure chamber 3, which is indicated by an arrow in FIG. 4.

In the negative pressure chamber 3, the conditioned food 2 is exposed to a negative pressure and then water is removed from it, preferably by sublimation, so that the food is freeze-dried. During freeze-drying, the food to be dried is first frozen. The water changes from the liquid to the solid state and is then transferred directly from the solid state to the gaseous state, it is sublimated.

In the embodiment shown, the negative pressure chamber therefore comprises a cooling device 20, which lowers the temperature in the negative pressure chamber, preferably to at least −18° C. The cooling device 20 in the embodiment shown is also connected via a cooling control line 21 to the central control unit 15 and is controlled by it.

In the exemplary device 1 shown in FIG. 4, both freezing and exposing to the negative pressure takes place in the negative pressure chamber 3. Of course, it is also possible to provide a cooling device 20 and a separate negative pressure chamber 3. For example, the cooling device 20 could be provided at the end of transport device 16, i.e. where the transfer from the transport device 16 to the negative pressure chamber 3 takes place, in order to freeze the food quickly to the desired temperature. Also conceivable are designs in which the negative pressure chamber 3 is equipped with a cooling device 20, which maintains the temperature in the negative pressure chamber at a low temperature desired for sublimation, and additionally a further cooling chamber in which the conditioned food 2 can be frozen quickly and energy-efficiently immediately before it is transferred into the negative pressure chamber 3.

To start the sublimation in the negative pressure chamber 3, the negative pressure chamber also has a treatment surface 22 on which the food 2 is placed in the negative pressure chamber 3. The treatment surface 22 is thermally coupled with a sublimation device 23, for example a sublimation heat exchanger 24, which supplies the food 2 with the thermal energy required for sublimation. The sublimation device 23 can also be connected via a sublimation control line 25 with the central control unit 15 and can be controlled by it.

The liquefier 5 is an apparatus in which the gaseous sublimated water removed from the food 2 is converted to the liquid state of aggregation. For this purpose, the liquefier 5 may contain one or more cooling coils 26 filled, for example, with silicone oil and cool the water gas extracted from the food 2. The other elements of the cooling circuit 27 of the liquefier 5 are shown schematically as a block in FIG. 4. The liquefier 5 is also connected to the central control unit 15 via a liquefier control line 28.

Even if it is not explicitly shown in FIG. 4, measuring devices, such as thermometers and/or manometers, can of course be provided in each of the chambers, i.e. the negative pressure chamber 3, the liquefier 5 and the conditioning chamber 8. These measuring devices record the currently prevailing conditions in the corresponding chamber and output them to the control unit 15, which evaluates these measured values and controls the conditions in the chambers accordingly.

The device according to the invention shown exemplarily in FIG. 4 may include further components not shown in FIG. 4. For example, the device may also include a pre-dewatering device connected, for example, between the conditioning chamber and the negative pressure chamber. In the pre-dewatering device, the food emerging from the conditioning chamber can be partially de-watered in such a way that any cell fluid emerging is removed before the food enters the negative pressure chamber. This reduces the amount of liquid to be effectively removed and accelerates the overall drying process.

In the following, some concrete test results are used to illustrate exemplary embodiments of the methods according to the invention.

### Experiment 1: Influence of Conditioning by Applying an Electric Field on the Product Properties/Quality of Fruit and Vegetables During the Freezing Process

The effect of PEF (pulsed electric fields) on product properties/quality during freezing was investigated. The aim was to clarify whether the product treated with PEF has better product properties/quality during freezing than the untreated product.
tested PEF settings: E=1.07 kV/cm
   W=>0.15 kJ/kg (depending on product)
   Pulse duration: 5-50 μsec
   Frequency: 2 Hz
Investigated: various fruit and vegetables were subjected to a PEF treatment and then frozen in a freezer at min. −18° C. These treated samples were compared with the untreated product during the freezing process. Bananas, carrots, bell peppers, kiwi and strawberries were examined.

### Process

The fruit and vegetables came from a local supermarket. It was cleaned of coarse dirt and thus prepared for further processing. Products that are hollow from the inside (e.g. bell peppers) were halved before the PEF treatment so that the air inclusions did not cause flashovers.

100 g of the products to be treated with PEF were placed in the treatment chamber. This was filled with 5 l tap water (22° C.). Products that floated due to their structure were pressed under water with a lid. Depending on the product, the fruit and vegetables were treated with different levels of energy input. The untreated product was also dipped once in a water bath to rule out this influence. Banana: 0.175 kJ/kg, 1.07 kV/cm; bell pepper: 1.0 kJ/kg, 1.07 kV/cm; carrot: 1 kJ/kg, 1.07 kV/cm; kiwi: 0.5 kJ/kg, 1.07 kV/cm; strawberry: 0.5 kJ/kg, 0.25 kV/cm.

The treated and untreated fruit and vegetables were then cut into small pieces and placed on trays in one layer. These trays were now frozen together with the product in a freezer (min. −18° C.) for several hours (up to days).

### Results

During the freezing process, it was found that the samples treated with PEF formed ice crystals on the surface earlier and area-wide than those that did not undergo PEF treatment.

As can be seen in FIG. 8, during the freezing of the carrots treated in accordance with the invention, a water film formed on the surface which forms an almost complete ice layer. In the case of untreated samples not in accordance with the invention which were not exposed to an electric field, however, only individual ice crystals are visible on the surface.

As can be seen in FIG. 9, the conditioning of food can release cell fluid on the surface of the food by applying an electric field. FIG. 9 shows an untreated carrot slice with no liquid visible on its surface (left). The right carrot slice of FIG. 9 was conditioned by applying an electric field. The PEF treatment led to cell fluid leaking out and accumulating on the surface. This also explains why a complete layer of ice forms on the surface of the carrots when they are frozen.

### Experiment 2: Influence of Food Conditioning on Product Properties/Quality by Applying an Electric Field During a Drying Process, in this Case a Freeze-Drying Process

The effect of PEF on product properties/quality in the freeze-drying process was investigated. The aim was to clarify whether the product treated with PEF has better product properties/quality after freeze-drying than the untreated product.
tested PEF settings: E=1.07 kV/cm
   W=>0.15 kJ/kg (depending on product)
   Pulse duration: 5-50 μsec
   Frequency: 2 Hz
investigated: various fruit and vegetables were subjected to a PEF treatment and compared with the untreated product after freeze-drying. Bananas, bell peppers and carrots were examined.

### Process

The fruit and vegetables came from a local supermarket. It was cleaned of coarse dirt and thus prepared for further processing. Products that are hollow from the inside (e.g. bell peppers) were halved before the PEF treatment so that the air inclusions did not cause flashovers.

100 g of bananas or 500 g of bell peppers to be treated with PEF were placed in the treatment chamber. This was filled with 5 l tap water (22° C.). Products that floated due to their structure were pressed under water with a lid. Depending on the product, the fruit and vegetables were treated with different levels of energy input (banana needed less than 0.5 kJ/kg, while a carrot needed more than 1 kJ/kg). The untreated product was also dipped once in a water bath to rule out this influence. Banana; 0.175 kJ/kg at 1.07 kV/cm; bell pepper: 1 kJ/kg, 1.07 kV/cm; carrot: 1 kJ/kg or 1.5 kJ/kg at 1.07 kV/cm.

The treated and untreated fruit and vegetables were then cut into small pieces and placed on trays in one layer. These trays were now frozen together with the product in a freezer (min. −18° C.) for several hours (up to days). Decisive for the further process was that the samples were frozen through.

After freezing through, the samples were placed on a stand provided for this purpose and freeze-dried. Two different series of freeze-drying experiments were carried out. In the first test series, the samples were dried in the Alpha 1-2 DL plus freeze-dryer (Martin Christ) for 15 h at a nominal value of 1 mbar. If the drying was incomplete after this time, a post-drying process was started which ran for a further 5 h with a setpoint of 0.0010 mbar. In the second test series of freeze-drying, the samples were dried in Alpha 1-3 LSD plus freeze drying (Martin Christ) with 0.5 mbar on heatable shelves with a shelf temperature of 30° C. until the product temperature reaches the shelf temperature.

### Results

When comparing the samples, PEF treated and untreated, some optical and structural differences were observed after the freeze-drying process. The same results were achieved in the two freeze-drying test series.

In the case of bell peppers, for example, the freeze-dried sample treated with PEF dried much faster than the untreated reference material. After the same time (15 h) this was still frozen or moist in the middle. Also optically the two samples differed clearly from each other. The sample treated with PEF remained dimensionally stable throughout the drying process and resembled the undried raw product, while the untreated sample shrank and collapsed during drying (see FIG. 5). The freeze-drying time of bell peppers could be reduced by 10 hours compared to the untreated reference material using the method according to the invention.

FIG. 5 shows the comparison of an untreated (left) and a PEF-treated (right) bell pepper after freeze-drying (E=1.07 kV/cm, 1 kJ/kg).

Positive effects could also be achieved during the freeze-drying of carrots. The carrots treated with PEF, for example, had a much more intense orange color after drying than the untreated reference (see FIG. 6).

FIG. 6 shows the comparison of untreated (left) with PEF treated (right) carrots after freeze-drying (E=1.07 kV/cm, 1 kJ/kg).

When viewing the cut surfaces of the dried material under a microscope, the structures shown in FIG. 7 could be recorded.

FIG. 7 shows the cross-section of a carrot after freeze-drying untreated (top) and treated with PEF (E=1.07 kV/cm, 1 kJ/kg) (bottom).

It can be clearly seen that the sample treated with PEF has a much more open-pored structure than the untreated sample. This observation could already be made in the bell pepper trials, where the product treated with PEF was spongy.

When tasting the samples, it was found for all products that the samples treated with PEF tasted crispier than the untreated reference material.

### REFERENCE NUMERALS

1 device
2 food
3 negative pressure chamber
4 vacuum pump
5 liquefier
6 valve
7 capacitor
8 conditioning chamber
9 suction line
10 connecting lines
11 electrodes
12 power lines
13 voltage source
14 control line from 13
15 control unit
16 transport device
17 conveyor belt
18 motor
19 motor control line
20 cooling device
21 cooling control line
22 treatment surface
23 sublimation device
24 sublimation heat exchanger
25 sublimation control line
26 cooling coil
27 cooling circuit
28 liquefier control line
29 pulse generator

1. Method for freezing food (2), in particular fruit and vegetables, wherein the food (2) is conditioned before or during freezing by applying an electric field.

2. Method for drying food (2), in particular fruit and vegetables, wherein the food (2) is exposed to a negative pressure and water is removed from the food (2) while exposed to the negative pressure, characterized in that the food (2) is conditioned by applying an electric field before the removal of the water.

3. Method according to claim 2, characterized in that the food (2) is frozen, preferably cooled to below −18° C., before the negative pressure is applied.

4. Method according to claim 3, characterized in that the food (2) is completely frozen through before the negative pressure is applied.

5. Method according to claim 3, characterized in that the food (2) is frozen according to the method according to claim 1.

6. Method according to one claim 1, characterized in that the food (2) is conditioned by means of electric pulses.

7. Method according to claim 6, characterized in that the food (2) is conditioned with at least 2 electric pulses, preferably with 10 to 200 and particularly preferably with 30 to 50 electric pulses.

8. Method according to claim 1, characterized in that during conditioning an energy input of at least 0.15 kJ/kg takes place and/or an electric field of 0.5 to 2 kV/cm is applied.

9. Method according to claim 1, characterized in that the food (2) is pre-dewatered after the step of conditioning.

10. Method according to claim 2, characterized in that the water is removed by sublimation.

11. Method according to claim 2, characterized in that a negative pressure of at least 3 mbar, preferably of at least 1 mbar, is applied.

12. Method according to claim 2, characterized in that the temperature of the food (2) during the entire drying process is below 30° C., preferably below room temperature and particularly preferably below 10° C.

13. Method according to claim 1, characterized in that a hollow food (2) is opened before conditioning.

14. Device (1) for drying food (2) according to the method according to claim 2, comprising:
a negative pressure chamber (3),
a vacuum pump (4) for generating a negative pressure in the negative pressure chamber (3), and
a liquefier (5) which is connected to the negative pressure chamber (3) via a closable valve (6),
characterized in that the device (1) further comprises a capacitor (7) for generating an electric field.

15. Device (1) according to claim 14, characterized in that the capacitor (7) comprises at least two electrodes (11) connected to a pulse generator (29).

16. Method according to claim 4, characterized in that the food (2) is frozen according to the method according to claim 1.

17. Method according to claim 3, characterized in that the water is removed by sublimation.

18. Method according to claim 3, characterized in that a negative pressure of at least 3 mbar, preferably of at least 1 mbar, is applied.

19. Method according to claim 3, characterized in that the temperature of the food (2) during the entire drying process is below 30° C., preferably below room temperature and particularly preferably below 10° C.

20. Method according to claim 2, characterized in that a hollow food (2) is opened before conditioning.
